(19) United States
(12) Patent Application Publication
(10) Pub. No.: US 2025/0196462 A1
(43) Pub. Date: Jun. 19, 2025

(54) A METHOD OF MAKING A THREE-DIMENSIONAL PRODUCT, AND A BLANK USEFUL FOR MAKING A THREE-DIMENSIONAL PRODUCT

(71) Applicant: CAMPEN MACHINERY A/S, Hornslet (DK)

(72) Inventors: Flemming KRISTENSEN, Hornslet (DK); Jens Erik Thordahl PETERSEN, Hornslet (DK)

(73) Assignee: CAMPEN MACHINERY A/S, Hornslet (DK)

(21) Appl. No.: 18/847,775

(22) PCT Filed: Mar. 20, 2023
(86) PCT No.: PCT/EP2023/057034

§ 371 Date: Sep. 17, 2024

(30) Foreign Application Priority Data
Mar. 23, 2022 (DK) PA202270136

(51) Int. Cl. B31B 50/64; B31B 50/46; B31B 50/59; B31B 100/00; B31B 110/20; B31B 110/35

(52) U.S. Cl. CPC B31B 50/64; B31B 50/46; B31B 50/592; B31B 2100/0024; B31B 2110/20; B31B 2110/35

(57) ABSTRACT

A method of making a three-dimensional product having a bottom and an upright peripheral wall extending from the bottom, by the hot pressing in a pressing cavity of a blank cut out of a web including at least a first layer of a non-woven airlaid fluff material.

The present invention concerns inter alia a method of making hot pressed three-dimensional products, in particular packaging products exhibiting a high degree of stability and resistance against leakage, on the basis of a web comprising natural fibers.

It is known in the art to manufacture three-dimensional packaging products on the basis of a non-woven airlaid fluff material web.

An example of a three-dimensional packaging product for cushioning and made on the basis of a non-woven airlaid fluff material web is disclosed in WO2022/009130. This packaging product cannot be considered leakage proof in that no provisions are made for tightly connecting the upstanding side panels to each other.

An example of a leakage proof three-dimensional packaging product made on the basis of a non-woven airlaid fluff material web is disclosed in WO2007/113750. Generally, when making such packaging products a flat rectangular blank that has been cut out of the web, is hot pressed in a mould cavity to form the three dimensional packaging product, which has a rectangular bottom and an upright peripheral wall that defines upright corners of the packaging product. The blank has a first portion which is to define the rectangular bottom of the packaging product, and which is integral with a surrounding, second portion that is to define the upright peripheral wall after the hot pressing of the blank. Through the hot pressing such packaging products show a high dimensional stability.

Known packaging products of the aforementioned leakage proof type are sometimes found to be problematic from an aesthetic point of view, especially where such packaging products have a relatively tall peripheral upright wall, and sometimes do not sufficiently resist leakage at the upright corners of liquid contents over a prolonged period of time, as may be the desired where the packaging product is to be used for containing meat with juices that should not escape the packaging product.

The aforementioned problems have been found largely related to the resulting densely compressed fiber structure of the prior art packaging products at the upright corners, in particular to damages caused by the shaping during the hot pressing.

The present invention aims at solving these problems by providing an improved method for making—in a highly economical manner—a three-dimensional product, useful as a packaging or for other use, on the basis of a one-piece blank made from a web of a non-woven airlaid fluff material comprising a) natural fibres, b) less than 10 percent by dry weight thermoplastic fibres, preferably no thermoplastic fibres at all, c) preferably less than 10 percent by dry weight adhesive, preferably no dry weight adhesive at all, and d) preferably less than 2 percent by dry weight of thermosetting resin, preferably no thermosetting resin at all.

The improved method comprises the steps defined in the appended method claim 1, wherein the blank, that has been cut to define a first, central segment and further, adjacent neighbouring segments projecting from the first segment, is shaped and processed using a hot pressing mould having a male part as well as a female part that defines a pressing cavity. Application of a pressure and heat sufficient for reorienting the projecting segments and for establishing hydrogen bonds then leads to the desired leakage proof three-dimensional product where natural fibers of overlapping or otherwise contacting edge portions of the adjacent, reoriented segments are bonded to each other to form seam lines and, hence, leakage proof upright corners of the three-dimensional product. The first segment in this manner defines the bottom of the three-dimensional product while the further segments together define a peripheral wall with upright corners of the three-dimensional product.

Hydrogen bonds may by way of example result between hydroxyl groups of cellulose and hemicellulose fibres. The presence of thermoplastic fibres have been found to inhibit formation of hydrogen bonds; hence, the layer where hydrogen bonding is established has less than 10% by dry weight of thermoplastic fibres, or no thermoplastic fibres.

The natural fibres may preferably be cellulose based fibres, preferably having a Kajaani Length (weighted) in an average length range of 1.8 to 4.0 mm. Using cellulose based fibres having a Kajaani Length (weighted) in the stipulated range has been found to provide a high strength network of such hydrogen bonded fibers where each cellulose based fiber is bonded to several other such fibers.

The blank cutting may preferably involve making a plurality of V-shaped or essentially V-shaped incisions in the blank to form a corresponding number of the projecting segments, with the tip of the V being at or close to the first segment referred to above.

Preferably, the surface temperature of opposite pressing surfaces of the hot pressing mould is in the order of 20° C.-200° C. when the hot pressing is carried out, and the pressure applied to the blank is preferably in the order of 2.0-200 kg/cm². Preferably, the pressing time is in the order of 1-5 seconds. It is also preferred that the moisture content of the web from which the blank is cut is in the order of 2 w %-25 w %, or less. Preferably, the reorienting is carried out entirely using the hot pressing mould, but some pre-reorienting of the further segments may have been carried out in a previous manufacturing step.

To reduce any tendency of the packaging to absorb moisture internal or surface sizing agents may be used, selected from the group of a fluorochemical, an alkyl ketene dimer (AKD), an alkenyl succinic anhydride (ASA), a rosin (acidic sizing), a wax, lignin, a modified starch and water glass. The non-woven airlaid fluff material may including a total of less than 2% by weight of such additives.

The web from which the blank is cut in the manner described above may comprise a single layer, namely a layer of the non-woven airlaid fluff material for hydrogen bonding, or natural and thermoplastic fibre layers in addition to the layer of the non-woven airlaid fluff material for hydrogen bonding. Where two such additional layers are used the non-woven airlaid fluff material for hydrogen bonding is sandwiched between the two additional layers. Where only a single such additional layer is used the hot pressing may be such that the additional layer faces the inside of the product, or the outside. Any such additional layers may contain thermoplastic fibres in amounts inhibiting hydrogen bonding, and may include the aforementioned internal sizing agent and/or surface sizing agents.

An independent claim is also directed to a blank which may be processed to form a three-dimensional product, using the aforementioned method.

Preferred embodiments are defined in the dependent claims.

The term “upright wall” as used herein may preferably designate a wall extending upwards and outwards from the product bottom at an angle α relative to the product bottom in the order of 90°-135°, preferably in the order of 95°-105°.

The term “web” as used herein may refer to the material being supplied for use in the method in long lengths or as relatively short length sheets.

### BRIEF DESCRIPTION OF THE DRAWINGS

FIG. 1 is a perspective view of a three-dimensional product manufactured in accordance with the present invention, having four corners and provided with a lid,

FIG. 2 is a top view of the product of FIG. 1, before the lid is applied,

FIG. 3 is a top view of a flat, cut blank for use in the method of the present invention,

FIGS. 4a and 4b are cross-sectional views showing the blank inserted into a hot pressing mould, before and during the hot pressing, respectively,

FIG. 5a-5f are schematic partial cross-sectional views illustrating different seam lines that may be formed at the upstanding corners of the product of FIG. 1, by a hydrogen bonding established between overlapping or otherwise contacting edge portions of neighbouring segments of the blank as a result of the hot pressing,

FIG. 6 is a perspective view of an alternative, taller three-dimensional product manufactured in accordance with the invention,

FIG. 7 is a top view of an alternative flat, cut blank for use in the method of the present invention, for making the product of FIG. 6,

FIGS. 8a and 8b show schematically a cross-sectional view of a portion of a one layer and three-layer web from which the blank of FIGS. 3 and 7 may be cut out,

FIGS. 9a-9b and 9c-9d show schematically how cutting dies for cutting the blanks may be configured to allow for the forming of an overlap bond or one kind of butt joint between neighbouring segments of the blank, respectively,

FIGS. 10a and 10b show schematically how the wall segments move to contact each other during the pressing, when the blank is cut out using one or the other die of FIG. 9a-d,

FIG. 11 shows an example of a cutting die, useful for making cuts where the pressing gives rise to butt joints of the type shown in FIG. 5b,

FIGS. 12a-12b show another embodiment of a three-dimensional product manufactured in accordance with the present invention, with lower portions of the upright corners pressed into the inside of the product, and

FIGS. 13a-13d are top and side views, respectively, of a pressing mould for making the product of FIGS. 12a-12b.

### DETAILED DESCRIPTION

The invention will now be explained in more detail below by reference to presently preferred embodiments.

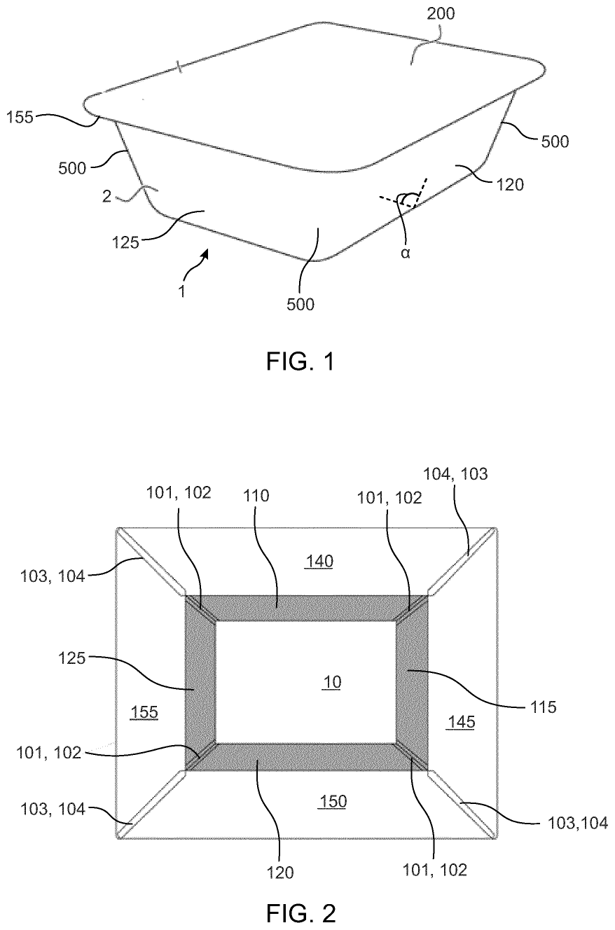

FIG. 1 shows an exemplary three-dimensional product, illustrated as a packaging product, i.e. as a packaging 1 having a peripheral wall 2 that defines rounded upright corners 500 of the packaging 1, and manufactured according to the method of the present invention. The packaging 1 has in the shown embodiment been provided with an optional lid 200, such as a plastic foil, attached to a peripheral rim of the packaging 1, such as by thermobonding, gluing, or similar. The shown wall 2 may by way of example extend upwards and outwards at an angle α relative to the packaging bottom in the order of 95°-105°. The height of the packaging 1, measured perpendicularly to the bottom, may be eg. in the order of 50-100 mm, as for food trays, eg. meat packagings.

FIG. 2 shows the packaging of FIG. 1 seen from above, without the lid 200 and illustrating the wall 2 and the bottom 10 of the packaging 1. The shown packaging 1 is an example of a final product 1 manufactured according to the method of the present invention.

The bottom 10 of the shown packaging 1 has a generally polygonal shape and the wall 2, which is integrally connected to the bottom 10, is composed of four segments 110, 115, 120, 125 that each extends upwards and outwards from a respective side of the bottom 10 at the selected angle α, each segment 110 having opposite edge portions 101, 102 and being bonded to a neighbouring segment 115 to form a respective one of the four upright corners 500. The bond defines a seam line, which seam line is established where an edge portion 101 of each of the segments 110 overlaps or otherwise contact a corresponding edge portion 102 of a neighbouring segment 115. The bond or seam is established by hydrogen bonding when practising the present invention, as discussed below, wherein a hot pressing forms the shape of the product 1, brings the edge portions together in an abutting or otherwise contacting engagement, and where the temperature and/or pressure is such that hydrogen bonds are established between natural fibres of one segment contacting those of the neighbouring segment.

FIG. 2 also shows the wall segments 110, 115, 120, 125 as having respective extensions 140, 145, 150, 155 configured to define the aforementioned peripheral rim of the packaging 1. The extensions 140, 145, 150, 155 each have opposite edge portions 103, 104, and at each one of the corners 500 one extension 140 is bonded to a neighbouring extension 145 via contacting edge portions 103, 104 in the same manner as for the aforementioned segments 110, 115, 120, 125 of the wall 2.

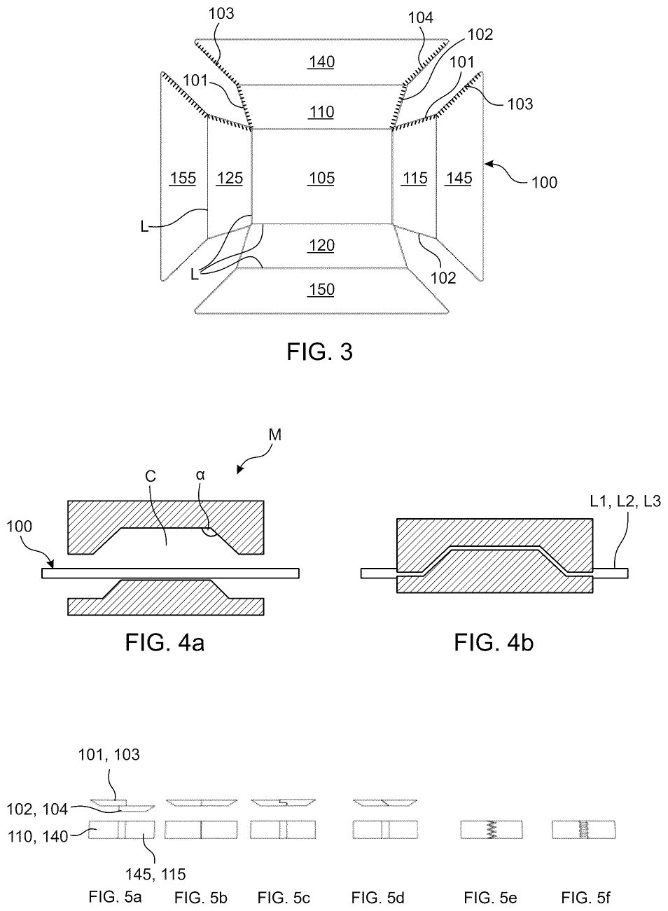

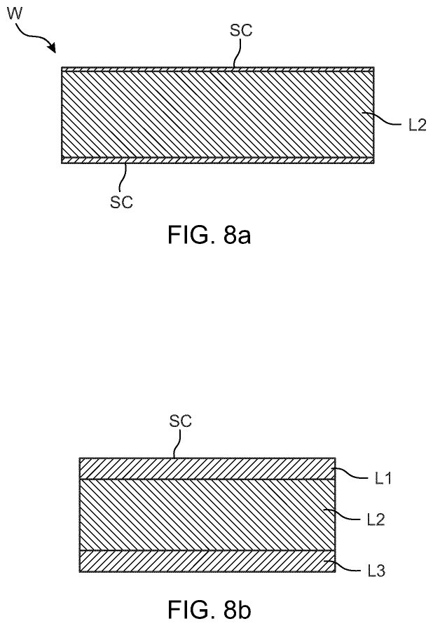

Turning now to FIG. 3 there is shown a flat blank 100 used for making the product 1 of FIG. 2. The blank 100 has been cut out in a punching operation from an elongated web W (see FIGS. 8a and 8b) consisting of a layer of a non-woven air-laid fluff material comprising a) natural fibres, b) less than 10 percent by dry weight thermoplastic fibres, preferably no thermoplastic fibres, c) preferably less than 10 percent by dry weight adhesive, preferably no dry weight adhesive, and d) preferably less than 2 percent by dry weight of thermosetting resin, preferably no thermosetting resin. The web W typically will have a moisture content in the order of 2 w %-25 w %, or less, at the time the hot pressing is carried out.

As shown in FIG. 3, the blank 100 comprises a first segment 105 configured to define the product bottom 10, and the aforementioned four further segments 110, 115, 120, 125 that project outwards from the first segment 105. The further segments 110, 115, 120, 125 are configured to define together the upright peripheral wall 20 after the hot pressing and each have respective opposite edge portions 101, 102. It will be understood that the further segments 110, 115, 120, 125 of the blank 100, by removing portions of the web W during the cutting out, are not connected to each other, other than via the first segment 105. Thus, the cutting out involves in this embodiment making four V-shaped incisions in the blank 100 to form a corresponding number of the segments 110, 115, 120, 125. The cutting out-step may also bring about a local modification of the structure of the blank 100 where the cuts are made, in the area where fibres of the resulting edge portions 101, 102 are to subsequently bond to each other by hydrogen bonding.

FIGS. 4a and 4b show schematically a hot pressing operation carried out on a cut out blank 100. Preferably, the surface temperature of the opposed pressing surfaces of a hot pressing mould M is in the order of 80° C.-200° C. when the hot pressing is carried out, and the pressure applied to the blank is preferably in the order of 2.0-200 kg/cm². Preferably, the pressing time is in the order of 1-5 seconds. The pressing leads to a reorienting, i.e. directional change, of the aforementioned further segments 110, 115, 120, 125, in that they are turned about respective virtual folding lines L shown in FIG. 3, by a predetermined angle of 180°−α, to obtain a product 1 with a peripheral wall 2 extending as shown in FIG. 1, compare with the corresponding angle α marked in FIG. 4a. The aforementioned incisions/cuts extend towards the anticipated folding lines L that result from the design of the pressing mould M, preferably not reaching the anticipated folding lines L.

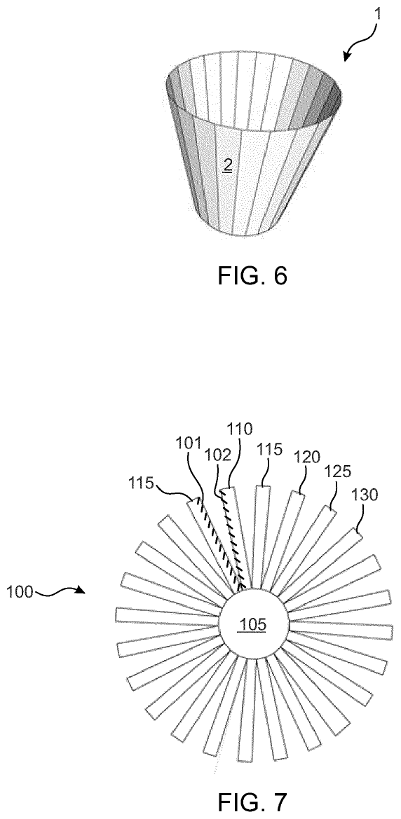

FIG. 5a-5f show schematic partial cross-sectional views illustrating variations in the joint between respective edge portions 101, 102; 103, 104 where a hydrogen bond is established during the hot pressing. The seam-like connection may arise from eg. the edge portions overlapping as shown in FIG. 5a, by forming a butt joint as shown in FIG. 5b, or by forming a tongue-and-groove joint as shown in FIGS. 5c-5f.

Turning now to FIG. 6, shown is an alternative embodiment wherein the product 1 takes the form of a ready-to-use drinking cup having a close to circular cross-section. FIG. 7 shows a blank 100 having a relatively high number of V-shaped incisions for making the cup of FIG. 6, wherein edge portions 101, 102 of neighbouring wall segments 110, 115, that extend radially outwards from the first segment 105 that has a round contour, are brought into engagement during the pressing and brought to bond to each other through the hydrogen bonding of the contacting natural fibers of adjacent wall segments 110, 115 resulting from the hot pressing. In this embodiment the height of the peripheral wall 20 measured perpendicularly to the bottom 10 of the resulting three-dimensional product 1 defined by the first segment 105 may be eg. in the order of 100-150 mm.

FIG. 8a shows one embodiment where the web W from which the blank 100 is cut has only a single layer L2, namely the non-woven airlaid fluff material type for hydrogen bonding. A surface sizing agent may be provided as a coating SC and being selected from the group of a fluorochemical, an alkyl ketene dimer (AKD), an alkenyl succinic anhydride (ASA), a rosin (acidic sizing), a wax, lignin, a modified starch and water glass.

FIG. 8b on the other hand shows an alternative embodiment where the web W from which the blank 100 is cut out and then hot pressed consists of three layers, wherein the center layer L2 is of the non-woven airlaid fluff material type for hydrogen bonding while the outer layers L1, L3 are layers that are bonded to the center layer L2 comprise natural fibers and thermoplastic fibres, preferably of the home and/or industrially compostable type. In this case the above mentioned hydrogen bonds across neighbouring abutting segments 110, 115, 120, 125 are established between the natural fibers of the center layer L2 as a result of the hot pressing. Additional bonds between thermoplastic fibers of the layers L1, L3 of abutting segments 110, 115, 120, 125 may also result from the hot pressing. A coating SC as mentioned above may be provided.

Alternatively, a web W comprising only a layer L2 of the non-woven airlaid fluff material for hydrogen bonding may be used together with only a single layer L3 comprising natural fibers and thermoplastic fibres of the aforementioned type. A coating SC as mentioned above may be provided.

The natural fibers referred to above may be selected from the following group: virgin cellulose based fibres, cellulose based fibres having a Kajaani Length (weighted) in an average length range of 1.8 to 4.0 mm, recycled fibres, such as recycled paper fibres, recycled craft fibers, recycled carton fibers, recycled milk carton fibers, recycled sackcloth fibers, TMP1 newspaper or magazine fibers, textile waste fibers, viscose fiber, bamboo fibers, nonwovens waste fibers, peat moss fibers, home compostable bonding fibers, and one year crop fibers, such as hemp-, cotton-, jute-, wheat-, coconut-, seaweed- or straw fibers.

The fibres may optionally be untreated or treated chemically and/or mechanically, such as to reduce or substantially remove lignin, while still allowing hydrogen bonds to be formed.

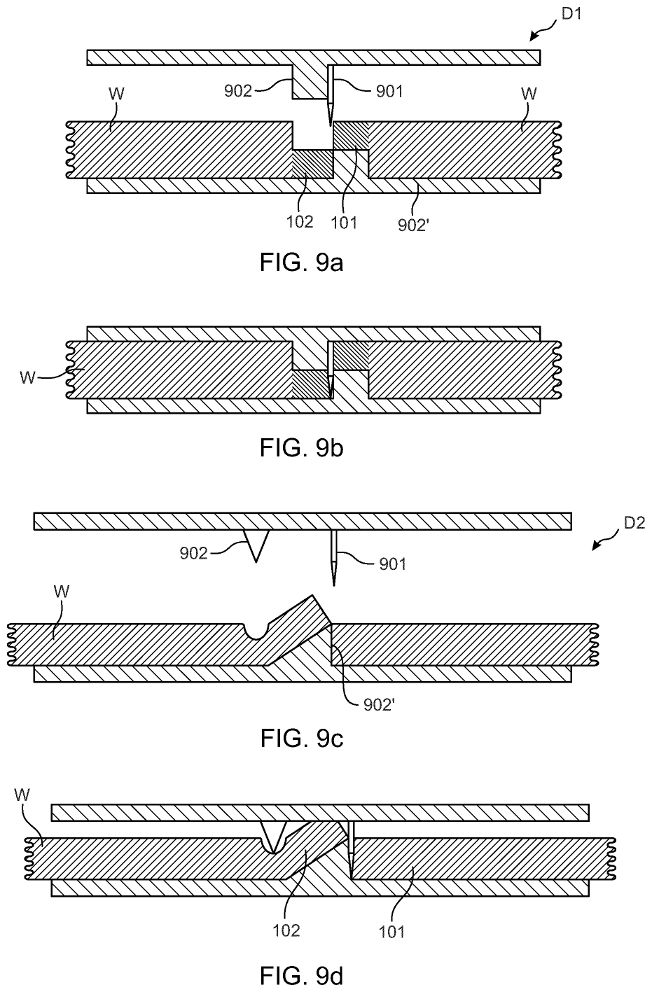

FIGS. 9a-9b and 9c-9d show schematically a cross-sectional view illustrating how cutting dies D1, D2 with knives 901 for performing the cutting out of the blank 100 from the web W may be configured to give rise to subsequent forming in the pressing mould M of either an overlap bond of the type shown in FIG. 5a or of a butt joint (end-to-end joint, as exemplified in FIG. 5c) between adjoining wall segments 110, 115 of the blank 100, respectively, by using die structures 902, 902′ that may compress or deform the opposite edge portions 101, 102. The cross-sectional views show the dies D1, D2 at the tip end of the knives 901, i.e. where the pointed end of the aforementioned V-shaped incision is made, close to the expected folding lines L. A local structural modification as referred to above is made in FIGS. 9b and 9d, by locally compressing the material.

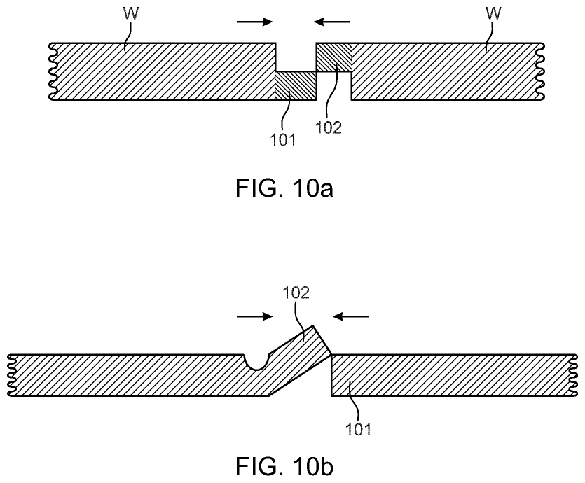

FIGS. 10a and 10b show schematically, with arrows, how the adjoining wall segments 110, 115 are displaced towards each other as the pressing mould M is closed, for the edge portions 101, 102 to contact, where the blank has been cut out using one or the other cutting die of FIG. 9a-d. Since this displacement is very small in the region where the folding about the lines L is brought about, the aforementioned incisions forming the segments 110, 115, 120, 125, 130 may preferably not extend fully to the expected location of the folding lines L, but only to a distance of eg. 2-5 mm from the folding lines L, so that in this region of the product very close to the bottom 10 the corners 500 of the product 1 are defined solely through the folding.

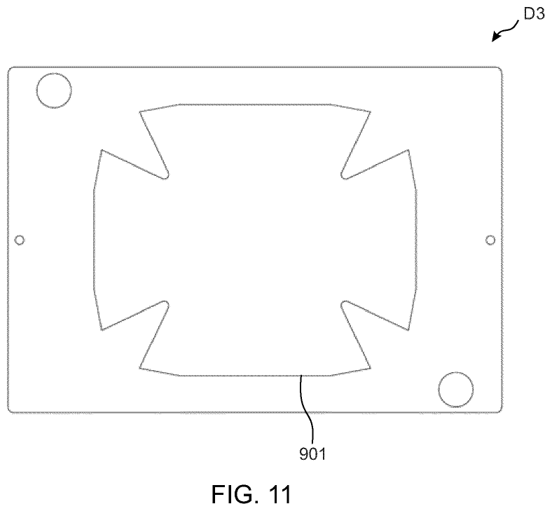

FIG. 11 is a top view of a cutting die D3 with a closed-loop knife 901, useful for making cuts where the closing and pressing of the pressure mould M gives rise to butt joints of the type shown in FIG. 5b.

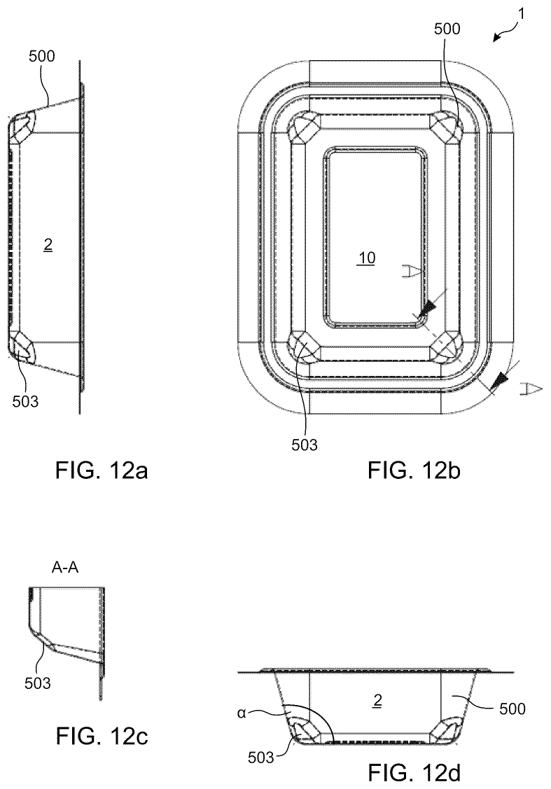

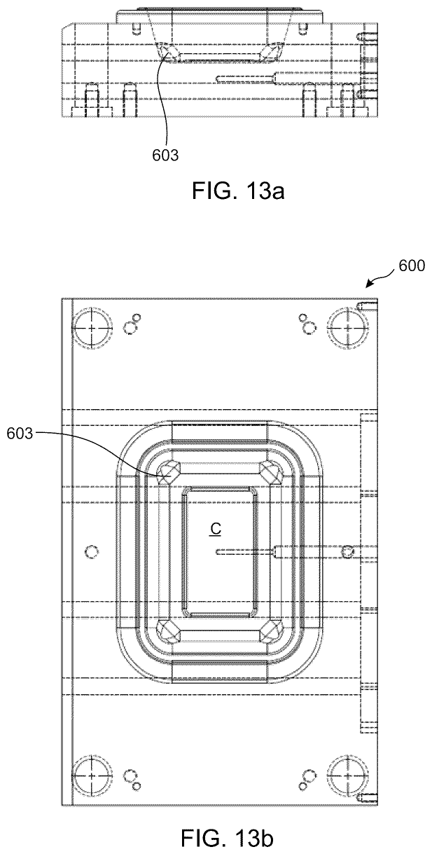

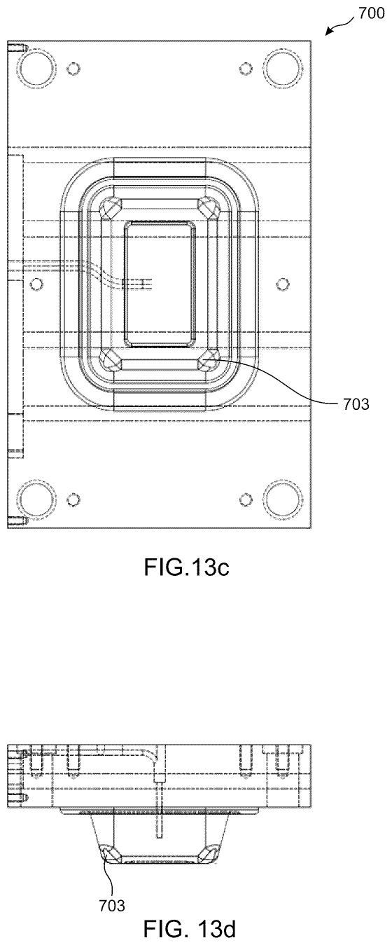

FIGS. 12a-12b show another embodiment of a three-dimensional product 1, in the form of a ready-to-use tray that may be eg. used for leakage proof containing of food with juices, manufactured in accordance with claimed embodiments of the present invention, such as with the aforementioned layer L2, layers L1 and L2, or with layers L1, L2 and L3, with lower portions 503, where the aforementioned hydrogen bonds are established, of the upright corners 500 extending into the inside of the product 1 as a result of the engagement between corresponding portions 603, 703 of the pressing mould M, of which the female part 600 with cavity C and the male part 700 is shown in FIGS. 13a, 13b and 13c, 13d, respectively.

1. A method of making a three-dimensional product comprising a bottom and an upright peripheral wall extending from said bottom, by hot pressing in a pressing cavity of a blank cut out of a web comprising a layer of a non-woven airlaid fluff material;
wherein said non-woven airlaid fluff material comprises:
natural fibers;
less than 10 percent by dry weight thermoplastic fibers;
less than 10 percent by dry weight adhesive; and
less than 2 percent by dry weight of thermosetting resin;
wherein said blank comprises:
a first segment configured to define said bottom; and
a plurality of further segments extending from said first segment and configured to define together said upright peripheral wall after said hot pressing, said plurality of further segments each comprising respective opposite edge portions;
said method comprising:
reorienting said further segments such that edge portions of neighboring further segments contact each other; and
wherein said hot pressing is selected such that a hydrogen bonding between said natural fibers of said edge portions of neighboring further segments that contact each other results from said hot pressing, to provide said three-dimensional product.

2. The method of claim 1, said natural fibers being virgin cellulose based fibers.

3. The method of claim 1, said natural fibers being cellulose based fibers.

4. The method of claim 1, wherein any thermoplastic fibers of said non-woven airlaid fluff material are home compostable thermoplastic fibers and/or industrially compostable thermoplastic fibers that have a length in the range of 3.0 to 18.0 mm.

5. The method of claim 1, said non-woven airlaid fluff material comprises no thermoplastic fibers.

6. The method according to claim 1, wherein said reorienting is carried out in said pressing cavity such that said edge portions contact each other in said pressing cavity.

7. The method according to claim 1, wherein said blank has a temperature of 80° C.-200° C. when said hot pressing is carried out, and/or wherein a pressure applied to said blank is at least 50 kg/cm² when said hot pressing is carried out.

8. The method according to claim 1, wherein said blank and a second blank are sequentially cut out of said web, said web and said blank and said second blank cut out of said web are continuously advanced to said pressing cavity.

9. The method according to claim 1, said web comprising only said layer of said non-woven airlaid fluff material, said layer defining opposite surfaces of said blank, wherein said hot pressing is selected such that a hydrogen bonding between said natural fibers of said contacting edge portions of said layer results from said hot pressing, to provide said three-dimensional product.

10. The method according to claim 2, wherein said edge portions of neighboring further segments that contact each other overlap by 1-5 mm or to form a butt joint.

11. The method of claim 9, said layer comprising an internal sizing agent and/or a surface sizing agent selected from the group consisting of: a fluorochemical, an alkyl ketene dimer (AKD), an alkenyl succinic anhydride (ASA), a rosin (acidic sizing), a wax, lignin, and a modified starch and water glass, or said non-woven airlaid fluff material comprising a total of less than 2% by weight of additives selected from the group consisting of: a fluorochemical, an alkyl ketene dimer (AKD), an alkenyl succinic anhydride (ASA), a rosin (acidic sizing), a wax, lignin, and a modified starch and water glass, said additives covering said natural fibers of said layer.

12. The method according to claim 1, said web from which said blank is cut out comprising a second layer carrying said layer of said non-woven airlaid fluff material, said layer defining a first surface of said blank and said second defining a second surface of said blank, said second layer comprising natural fibers and thermoplastic fibers, said thermoplastic fibers having a length in the range of 3.0 to 18.0 mm.

13. The method according to claim 1, said web from which said blank is cut out comprising said layer of said non-woven airlaid fluff material sandwiched between a second layer and a third layer, each of the second layer and the third layer comprising natural fibers and thermoplastic fibers, and defining a respective surface of said blank, wherein said hot pressing is selected such that a bonding results, between said thermoplastic fibers, across said edge portions of neighboring further segments contacting each other.

14. The method according to claim 13, at least one of said second layer and said third layer comprising an internal sizing agent and/or a surface sizing agent selected from the group consisting of: a fluorochemical, an alkyl ketene dimer (AKD), an alkenyl succinic anhydride (ASA), a rosin (acidic sizing), a wax, lignin, a modified starch and water glass, or said at least one of said second layer and said third layer comprising a total of less than 2% by weight of additives selected from the group consisting of: a fluorochemical, an alkyl ketene dimer (AKD), an alkenyl succinic anhydride (ASA), a rosin (acidic sizing), a wax, lignin, and a modified starch and water glass, said additives covering said natural fibers of said at least one of said second layer and said third layer.

15. The method according to claim 1, said first segment having a polygonal or round contour.

16. The method according to claim 1, each of said plurality of further segments comprising an extension with respective second edge portions, whereby second edge portions of neighboring extensions contact each other when said blank is hot pressed in said pressing cavity, and wherein a hydrogen bonding between said natural fibers of said second edge portions of said extensions that contact one another result from said hot pressing, to provide a peripheral rim portion of said three-dimensional product.

17. The method according to claim 1, said natural fibers being:
virgin cellulose based fibers, cellulose based fibers having a Kajaani Length (weighted) in an average length range of 1.8 to 4.0 mm, recycled fibers, TMP1 newspaper or magazine fibers, textile waste fibers, viscose fiber, bamboo fibers, nonwovens waste fibers, peat moss fibers, home compostable bonding fibers, or one year crop fibers.

18. The method according to claim 1, wherein said blank is cut out of said web by a punching operation, and/or wherein said blank is cut out of said web by forming V-formed, or essentially V-formed, incisions in said blank.

19. The method according to claim 1, said blank having a thickness selected in a range of 1.5 mm-20 mm.

20. The method according to claim 1, said blank having a density selected in a range of 30 kg/cm³-350 kg/m³, and said three-dimensional product having a density of 700 kg/cm³-1,500 kg/cm³.

21. A three-dimensional product comprising a bottom and an upright peripheral wall extending from said bottom, by hot pressing in a pressing cavity of a blank cut out of a web comprising a layer of a non-woven airlaid fluff material;
wherein said non-woven airlaid fluff material comprises:
natural fibers;
less than 10 percent by dry weight thermoplastic fibers;
less than 10 percent by dry weight adhesive; and
less than 2 percent by dry weight of thermosetting resin;
wherein said blank comprises:
a first segment configured to define said bottom; and
a plurality of further segments extending from said first segment and configured to define together said upright peripheral wall after said hot pressing, said plurality of further segments each comprising respective opposite edge portions;
wherein said three-dimensional product is manufactured by the method comprising:
reorienting said further segments such that edge portions of neighboring further segments contact each other; and
wherein said hot pressing is selected such that a hydrogen bonding between said natural fibers of said edge portions of neighboring further segments that contact each other results from said hot pressing, to provide said three-dimensional product.

22. (canceled)

23. A flat or substantially flat blank comprising:
a layer of a non-woven airlaid fluff material comprising:
a first segment with a polygonal or round contour; and
a plurality of further segments projecting outwards from said first segment;
wherein said blank has a density selected in a range of 30 kg/cm³-350 kg/m³ and a thickness selected in a range of 1.5 mm-20 mm;
wherein said layer comprises:
natural fibers;
less than 10 percent by dry weight thermoplastic fibers;
less than 10 percent by dry weight adhesive; and
less than 2 percent by dry weight of thermosetting resin.

24. The flat or substantially flat blank of claim 23, said natural fibers being selected from the group consisting of:
virgin cellulose based fibers, cellulose based fibers having a Kajaani Length (weighted) in an average length range of 1.8 to 4.0 mm, recycled fibers, TMP1 newspaper or magazine fibers, textile waste fibers, viscose fiber, bamboo fibers, nonwovens waste fibers, peat moss fibers, home compostable bonding fibers, and one year crop fibers.

25. The flat or substantially flat blank according to claim 24, wherein said fibers being untreated or treated chemically and/or mechanically, such as to reduce or substantially remove lignin; and
said fluff comprising an internal sizing agent and/or a surface sizing agent increasing the hydrophobic properties and/or mechanical strength of said blank, wherein said internal sizing agent and/or surface sizing agent is a fluorochemical, an alkyl ketene dimer (AKD), an alkenyl succinic anhydride (ASA), a rosin (acidic sizing), a wax, lignin, a modified starch. or water glass.

26. The method according to claim 17, wherein said fibers being untreated or treated chemically and/or mechanically, such as to reduce or substantially remove lignin; and
said fluff comprising an internal sizing agent and/or a surface sizing agent increasing the hydrophobic properties and/or mechanical strength of said blank, wherein said internal sizing agent and/or surface sizing agent is a fluorochemical, an alkyl ketene dimer (AKD), an alkenyl succinic anhydride (ASA), a rosin (acidic sizing), a wax, lignin, a modified starch. or water glass.
